(19) United States
(12) Patent Application Publication
(10) Pub. No.: US 2014/0216901 A1
(43) Pub. Date: Aug. 7, 2014

(54) CONVEYING CHAIN

(71) Applicant: MING-CHANG TRAFFIC PARTS MANUFACTURING CO., LTD., Pingtung County 900 (TW)

(72) Inventor: YI-CHENG HUANG, PINGTUNG COUNTY 900 (TW)

(73) Assignee: MING-CHANG TRAFFIC PARTS MANUFACTURING CO., LTD., Pingtung County 900 (TW)

(21) Appl. No.: 14/147,677

(22) Filed: Jan. 6, 2014

(30) Foreign Application Priority Data
Feb. 5, 2013 (TW) 102202470

(51) Int. Cl. B65G 15/48

(52) U.S. Cl. CPC B65G 15/48
USPC 198/851

(57) ABSTRACT

A conveying chain comprises a plurality of chain sets connected together, each chain set comprises a chain bush, inner plates and outer plates respectively disposed on both sides of the chain bush, and a pin member penetrating the chain bush and connecting the inner and the outer plates, wherein a plurality of openings are defined at intervals on a circumference of the chain bush. A through hole is communicated with an outside via the openings, so that dust or exterior impurities accumulated between the chain bush and the pin member can be outwardly discharged through the openings to prevent the accumulation of the dust or impurities from having an adverse influence on the transmission of the chain and to increase the smoothness of the chain operation and the use duration efficiently.

### BACKGROUND OF THE INVENTION

1. Field of the Invention

The present invention relates to a chain design, particularly to a conveying chain.

2. Description of the Related Art

Nowadays, transmission works of a variety of machinery apparatus are mostly driven with chains. Referring to FIG. 1, the conventional chain 1 comprises a plurality of chain sets 11 connected together, each chain set 11 comprises a pin member 110, inner plates 111, outer plates 112, and a chain bush 113. Wherein, a hole 1131 is formed in an inside of the chain bush 113, and a connecting portion 1101 is protruded outwards from both ends of the pin member 110 for allowing the inner plates 111 and the outer plates 112 to fit thereon. Therefore, the chain 1 achieves an effect of transmission or conveyance, which accordingly facilitates a generated force to be smoothly transmitted, or an object to be conveyed easily.

However, after using, referring to FIG. 2, the chain bush 113 is penetrated by the pin member 110, and both ends of the chain bush 113 are overlapped by the inner plates 111. The hole 1131 formed in the inside of the chain bush 113 cannot be entirely sealed by the inner plates 111, namely, a gap (as shown) between the inner plates 111 and the chain bush 113 is generated. While the chain 1 is used to execute a conveyance or a transmission work, dust drifted in operating surroundings or other exterior impurities are apt to enter from the aforesaid gap into the hole 1131. Further, a left room between the chain bush 113 and the pin member 110 are limited, and a length of the chain bush 113 causes the dust or the impurities entering into the hole 1131 to be discharged ineffectively. As a result, a lubricant inside of the chain bush 113 mixes with the dust or the impurities and generates an accumulation of the dirt. A long period of the accumulation of dirt causes the pin member 110 to be stuck in the chain bush 113 and influences the rotation of the pin member 110. Correspondingly, a wear of the chain 1 is formed while the pin member 110 cannot be smoothly rotated, and a wear of the pin member 110 also shortens the use duration of the chain 1.

### SUMMARY OF THE INVENTION

The purpose of the present invention is to provide a conveying chain for preventing the accumulation of the dust and decreasing the wear of the chain in use, thereby increasing the smoothness of the chain operation and the use duration efficiently.

Accordingly, the conveying chain comprises a plurality of chain sets connected together, and each chain set comprises a pin member, inner plates, outer plates, and a chain bush. Wherein, a through hole is formed in an inside of the chain bush, a plurality of openings are defined at intervals on the chain bush, and the through hole is communicated with an outside through the openings. Therefore, during transmission procedures of the conveying chain, the dust or the exterior impurities entering into the through hole can be promptly discharged via the openings and will not gather between the chain bush and the pin member for preventing the rotation of the pin member from being affected by an accumulation of the dust, whereby the smoothness of the chain operation and the use duration of the chain are both promoted.

Preferably, the chain bush is a spring-wire-type sleeve, whereby the through hole is enclosed by the sleeve, and the openings are defined between a continuous helical wire of the spring-wire-type sleeve.

Preferably, the chain bush contains a plurality of ring units, each of the openings is defined between any two adjacent ring units for allowing the ring units to be disposed at intervals.

The advantages of the present invention over the known prior arts are more apparent to those of ordinary skilled in the art upon reading following descriptions in junction with the drawings.

### BRIEF DESCRIPTION OF THE DRAWINGS

FIG. 1 is a cross-sectional view showing a configuration of a conventional conveying chain;

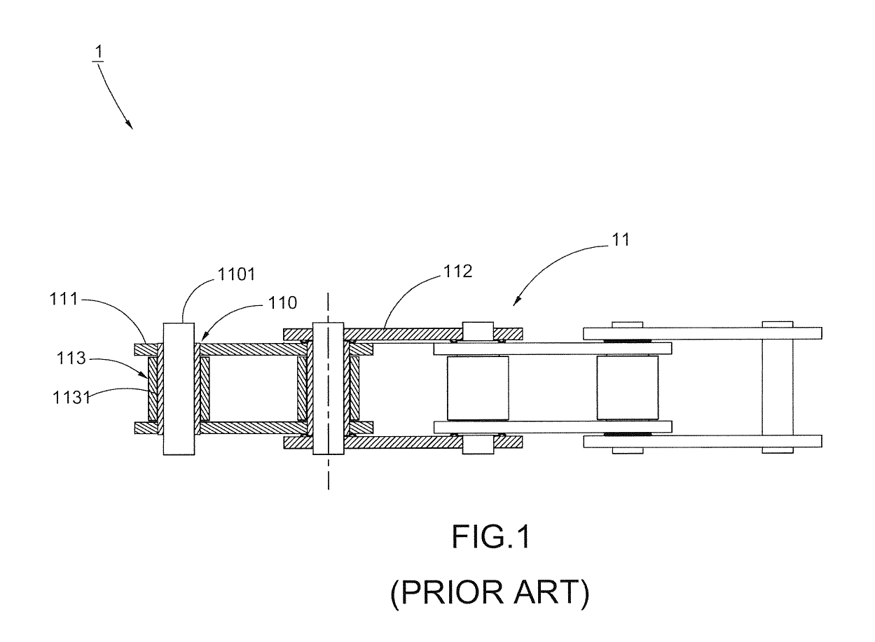

FIG. 2 is a partial enlarged view of FIG. 1;

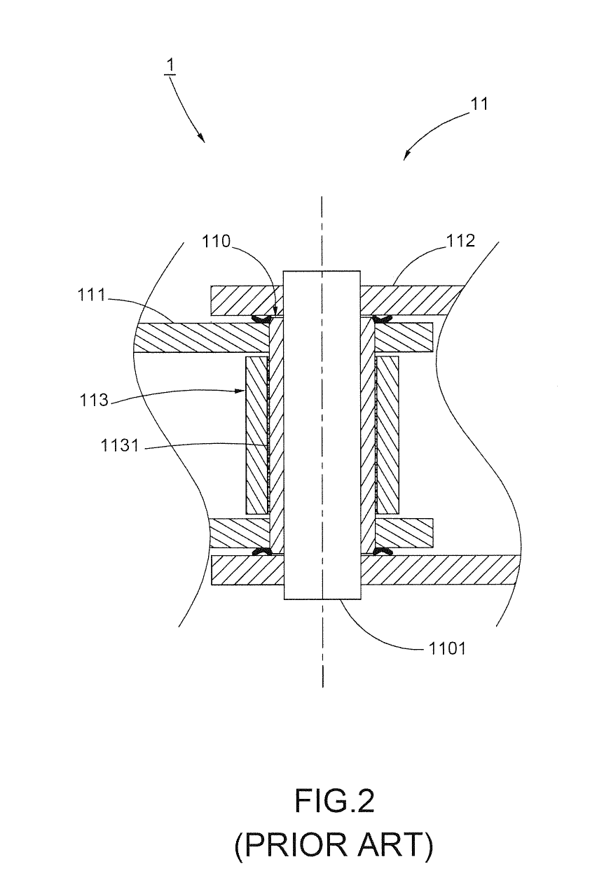

FIG. 3 is a schematic view showing a first preferred embodiment of the present invention;

FIG. 4 is a cross-sectional view showing the configuration of FIG. 3;

FIG. 5 is a schematic view showing a second preferred embodiment of the present invention;

FIG. 6 is a cross-sectional view of FIG. 5; and

FIG. 7 is a cross-sectional view showing a third preferred embodiment of the present invention.

### DETAILED DESCRIPTION OF THE PREFERRED EMBODIMENTS

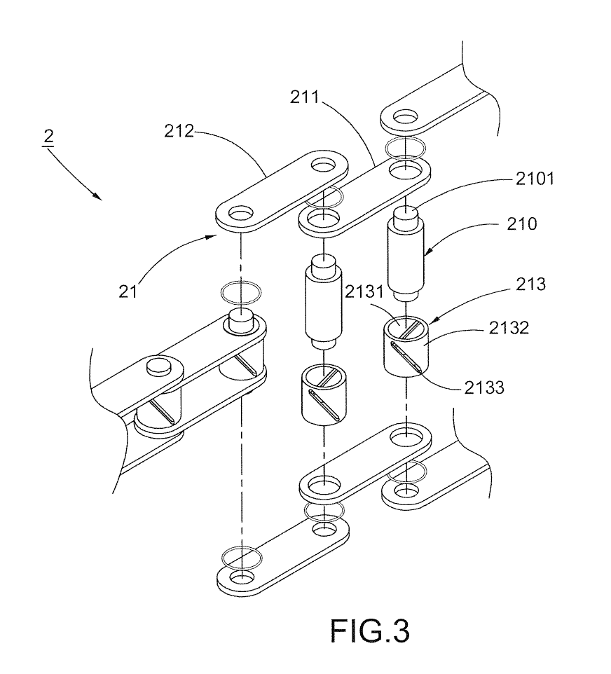

Referring to FIG. 3, a first preferred embodiment of the conveying chain 2 comprises a plurality of chain sets 21 connected together. Each chain set 21 comprises a chain bush 213, inner and outer plates 211,212 respectively disposed on both sides of the chain bush 213, and a pin member 210 penetrating the chain bush 213 and fitting with the inner and the outer plates 211,212. A through hole 2131 is formed in an inside of the chain bush 213 for allowing the pin member 210 to penetrate and fit therein. A connecting portion 2101 can be integrally protruded from the pin member 210 for allowing the inner and the outer plates 211,212 to place thereon, or alternatively, in this embodiment, the connecting portion 2101 is an independent shaft penetrating through the pin member 210, whereby the connecting portion 2101 is able to protrude from both ends of the pin member 210 respectively. A plurality of openings 2133 are defined at intervals on a circumference 2132 of the chain bush 213, the openings 2133 can be formed in a variety of shapes, and the through hole 2131 is communicated with an outside via the openings 2133.

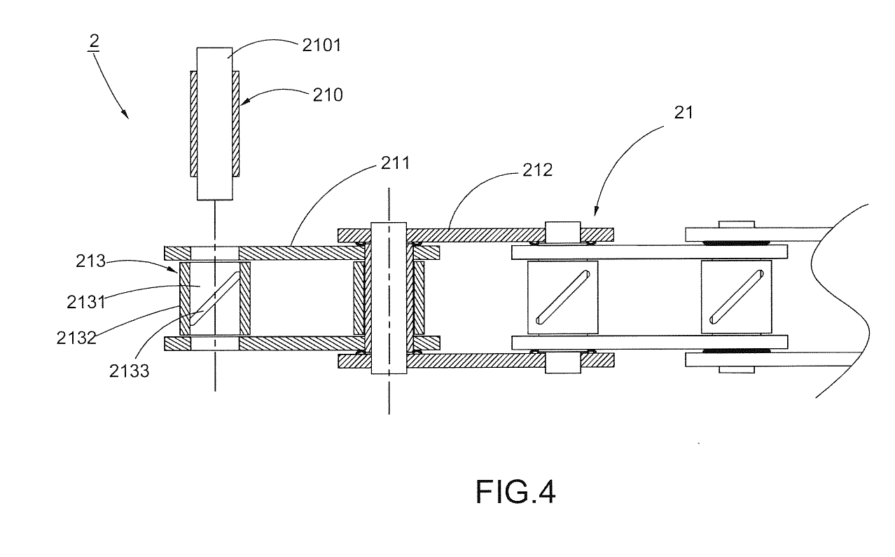

Consulting FIG. 4, while the conveying chain 2 is under operation, the dust originally existed in the surrounding environment, the dust generated during the auxiliary operation of the chain 2, or the exterior impurities are drifted in the operating environment. The inner plates 211 cannot entirely seal the through hole 2131 formed in the inside of the chain bush 213, so a gap between the inner plates 211 and the chain bush 213 is inevitably generated. As a result, the dust and the exterior impurities are apt to enter from the gap into the interstice formed between the pin member 210 and the chain bush 213. By a plurality of openings 2133 defined on the circumference 2132 of the chain bush 213 and communicated with the through hole 2131, the dust or the dirt formed by mixing the dust with the lubricant inside of the chain bush 213 can be fast discharged via the openings 2133 during the motion of each chain set 21. As a result, the dust or the exterior impurities will not gather in the chain bush 213 for a long time for preventing the pin member 210 from being affected by the dust and the dirt and causing a wear and damages. Whereby, the chain 2 is transmitted or conveyed smoothly, and the use duration of the chain 2 is substantially prolonged. While the chain 2 is not operated, the operator can check the actual accumulation of the dust or the dirt of each chain set 21 via openings 2133. With clean works properly executed by the operator, the smoothness of the chain operation and the use duration of the chain 2 can be further improved.

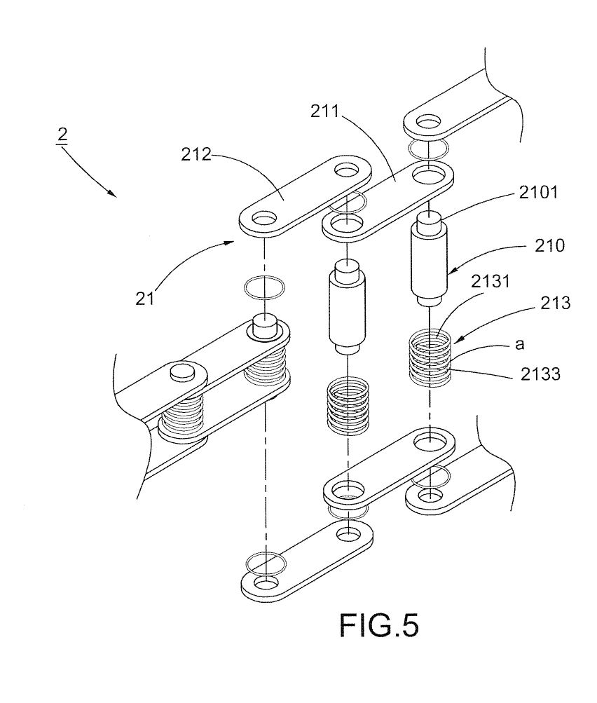

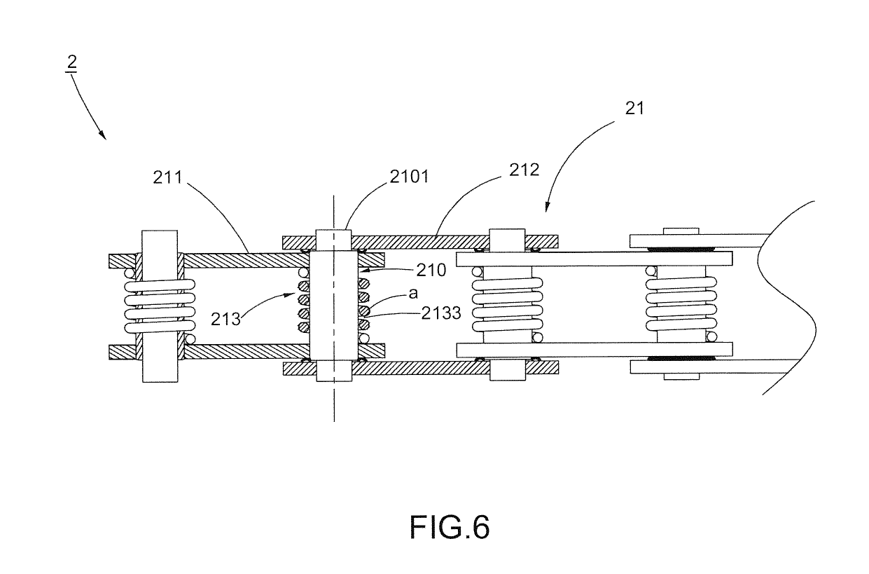

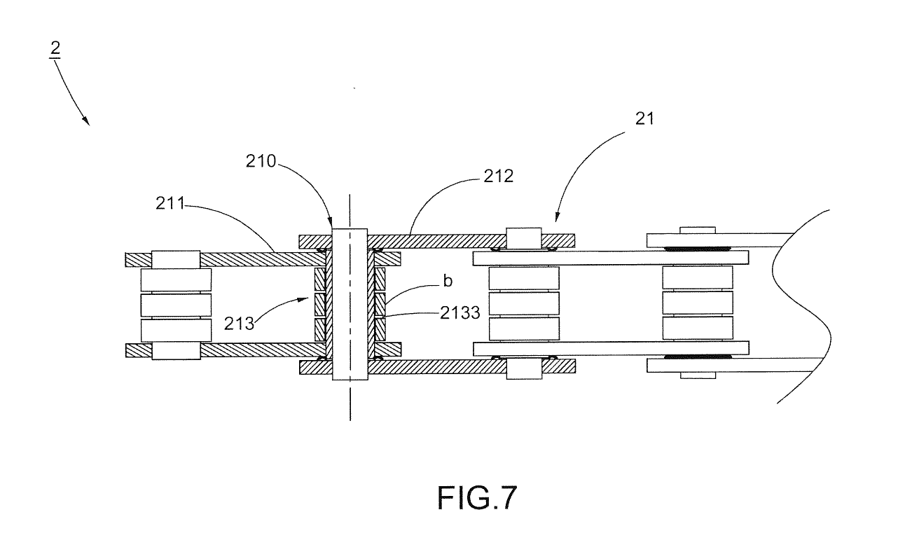

Accompanying with FIG. 5 and FIG. 6, the second preferred embodiment of the conveying chain 2 still comprises a plurality of chain sets 21 connected together. Each chain set 21 comprises a pin member 210, inner plates 211, outer plates 212, and a chain bush 213. Wherein, in this embodiment, the chain bush 213 can be a spring-wire-type sleeve a, and the through hole 2131 is enclosed by the spring-wire-type sleeve a. Gaps formed between a continuous helical wire of the spring-wire-type sleeve a are defined as the openings 2133, and the through hole 2131 is communicated with the outside via the openings 2133. Relatively, the dust or the exterior impurities gathered between the chain bush 213 and the pin member 210 can be outwardly discharged through the openings 2133 for preventing the accumulation of the dust in the chain bush 213 from having an adverse influence on the transmission of the chain 2, thereby improving the smoothness of the chain operation and the use duration of the chain 2 efficiently. Referring to FIG. 7, a third preferred embodiment of the chain 2 still comprises a plurality of chain sets 21 connected together, and each chain set 21 comprises a pin member 210, inner plates 211, outer plates 212, and a chain bush 213. Notably, in this embodiment, the chain bush 213 contains a plurality of ring units b. Each of the openings 2133 is defined between any two adjacent ring units b for allowing the rings units b to be disposed at intervals, and herein only three ring units b are shown in this figure. As a consequence, the dust caused during the auxiliary operation of the chain 2 or the exterior impurities are drifted in the operating environment and can be fast discharged from the gaps between any two of adjacent ring units b for keeping the pin member 210 from having the wear and the damages caused by the long period accumulation of the dust or dirt in the chain bush 213. At the same time, a transmission characteristic of the conveying chain 2 remains unaffected by the over accumulation of the dust, whereby the smoothness of chain operation and the use duration of chain 2 are effectively promoted.

To sum up, the present invention mainly uses a plurality of openings defined on the chain bush. The chain bush can be a solid sleeve, a spring-wire-type sleeve, or a combination of spaced-apart ring units for allowing the through hole formed in the inside of the chain bush to being communicated with the outside via the openings. Consequently, even if the dust or the exterior impurities in the operating environment entering into the chain bush can be promptly discharged via the openings for preventing the over accumulation of the dust and the dirt from causing the wear and the damages of the pin member and for smoothly transmitting the chain, thereby making sure the use duration of the chain is improved.

While we have shown and described the embodiment in accordance with the present invention, it should be clear to those skilled in the art that further embodiments may be made without departing from the scope of the present invention.

What is claimed is:

1. A conveying chain comprising a plurality of chain sets connected together, each chain set comprising a chain bush, inner plates and outer plates respectively disposed on both sides of said chain bush, and a pin member penetrating said chain bush and connecting said inner plates and said outer plates, wherein a through hole is formed in an inside of said chain bush for allowing said pin member to penetrate and fit therein, a connecting portion being protruded outwards from said pin member for being sleeved by said inner plates and said outer plates, a plurality of openings being defined at intervals on a circumference of said chain bush, said through hole being communicated with an outside via said openings. The conveying chain as claimed in claim 1, wherein said chain bush is a spring-wire-type sleeve, whereby said through hole is enclosed by said sleeve, and said openings are defined between a continuous helical wire of said spring-wire-type sleeve. The conveying chain as claimed in claim 1, wherein said chain bush contains a plurality of ring units, each of said openings being defined between any two adjacent ring units for allowing said ring units to be disposed at intervals.
